(19) United States
(12) Patent Application Publication
(10) Pub. No.: US 2026/0122047 A1
(43) Pub. Date: Apr. 30, 2026

(54) Encrypted communications

(71) Applicant: STREAMWIDE, Paris (FR)

(72) Inventor: Pierre BODILIS, Paris (FR)

(73) Assignee: STREAMWIDE, Paris (FR)

(21) Appl. No.: 19/368,857

(22) Filed: Oct. 24, 2025

(30) Foreign Application Priority Data
Oct. 25, 2024 (FR) 2411709

(51) Int. Cl. H04L 9/40; H04L 9/08; H04L 65/1069

(52) U.S. Cl. CPC H04L 63/0457; H04L 9/0838; H04L 65/1069

(57) ABSTRACT

Examples presenting solutions for performing end-to-end encryption.

### TECHNICAL FIELD

This disclosure relates to the field of encrypted communications.

### PRIOR ART

Communications security is an issue in various industrial sectors. In particular, a great deal of information is now exchanged via conference sessions. These sessions are generally in real-time and involve multiple participants connected to the conference session via an electronic device. Encrypting communications during these conference sessions can prove to be complex.

This disclosure improves the situation.

### SUMMARY

In this regard, a method is proposed for exchanging data with end-to-end encryption between a first terminal and a second terminal participating in a conference session managed by a media server, wherein a communication channel is established between the media server and a browser of the first terminal, and wherein the method comprises:
a first encryption of a multimedia stream by the second terminal, using a first encryption key associated with the conference session;
a sending of the encrypted multimedia stream to the media server by the second terminal;
a second encryption of the already-encrypted multimedia stream, by the media server, using an encryption key negotiated between the browser of the first terminal and the media server for communicating on the communication channel; then
a sending of the multimedia stream to the first terminal, by the media server.

Optionally, the method further comprises a first decryption, by the first terminal, of the multimedia stream received from the media server, using the encryption key negotiated between the browser of the first terminal and the media server; and
a second decryption of the multimedia stream, by the first terminal, using a second encryption key, which allows decrypting a multimedia stream encrypted by the first encryption key.

Optionally, the second decryption comprises:
loading a bytecode file comprising a decryption function for decrypting a data stream; and executing the decryption function on the multimedia stream.

Optionally, the browser of the first terminal further comprises a coding module which allows encoding or decoding multimedia streams using a plurality of codecs, wherein the method further comprises:
an encoding of the multimedia stream by the second terminal, using a first codec; and
when the first codec is one among the plurality of codecs:
a decoding of the multimedia stream using the browser's coding module.

Optionally, when the first codec is not one among the plurality of codecs supported by the coding module, the method further comprises:
loading a bytecode file comprising a decoding function for decoding a data stream encoded using the first codec; and
executing the decoding function on the multimedia stream encoded by the first codec.

Optionally, the communication channel between the media server and the browser is established in accordance with a WebSocket protocol;
and a sending of the multimedia stream to the first terminal, by the media server, via the communication channel established between the media server and the browser of the first terminal, comprises:
writing the multimedia stream to the communication channel established between the media server and the browser.

The application also relates to a terminal adapted for connecting to a conference session managed by a media server, the terminal comprising a browser, wherein the terminal is configured for:
applying a first encryption of a multimedia stream using a third encryption key associated with the conference session;
applying a second encryption of the multimedia stream that was encrypted using the third encryption key, using an encryption key negotiated between the browser and the media server to encrypt the multimedia streams exchanged between the media server and the browser; and
transmitting the encrypted multimedia stream to the media server.

Optionally, the terminal may also be configured for:
obtaining, from the media server, a multimedia stream encrypted a first time using a first encryption key of another terminal participating in the conference, and encrypted a second time using an encryption key negotiated between the browser and the media server to encrypt the multimedia streams exchanged between the media server and the browser;
applying a first decryption of the multimedia stream received from the media server, using the encryption key negotiated between the browser and the media server; and
applying a second decryption of the multimedia stream received from the media server, using a second encryption key which allows decrypting a multimedia stream encrypted by the first encryption key.

Optionally, the application of the second decryption of the multimedia stream comprises:
loading a bytecode file comprising a decryption function for decrypting a data stream; and
executing the decryption function on the multimedia stream.

The application further relates to a media server configured for managing a conference session in which at least a first terminal and a second terminal are participating, wherein the media server is configured for:
receiving, from the second terminal, an encrypted multimedia stream to be transmitted to the other participants in the conference session; and
encrypting the already encrypted multimedia stream, using an encryption key negotiated with a browser of the first terminal.

The application further relates to a computer program product comprising instructions for implementing all or part of any of the methods presented by this disclosure when the program is executed by a processor.

Finally, the application relates to a non-transitory computer-readable storage medium on which is stored a program for implementing all or part of any of the methods presented by this disclosure when the program is executed by a processor.

### BRIEF DESCRIPTION OF DRAWINGS

Other features, details, and advantages will become apparent upon reading the detailed description below and upon analyzing the attached drawings, in which:

FIG. 1 schematically represents an example of a communication architecture according to this disclosure.

FIG. 2 schematically represents an example of a terminal according to this disclosure.

FIG. 3 schematically represents an example of a first terminal according to this disclosure.

FIG. 4 schematically represents an example of a media server according to this disclosure.

FIG. 5 schematically represents an example of a method for exchanging data with end-to-end encryption.

FIG. 6 schematically represents another example of a method for exchanging data with end-to-end encryption.

FIG. 7 schematically represents yet another example of a method for exchanging data with end-to-end encryption.

FIG. 8 schematically represents yet another example of a method for exchanging data with end-to-end encryption.

FIG. 9 schematically represents yet another example of a method for exchanging data with end-to-end encryption.

FIG. 10 schematically represents examples of operations that may be implemented by a terminal according to this disclosure.

### DESCRIPTION OF EMBODIMENTS

The inventor noted that conference sessions allowing the exchange of audio or video data streams could involve participants who use the functionalities offered by browsers to process and read the exchanged data streams. The exchange of data streams in these conference sessions is based on the Real Time Transport Protocol (RTP), i.e. these data exchanges comply with the RFC 3550 standard.

However, using a browser to exchange data streams with a media server (which corresponds to the server managing the conference session, in particular redirecting the data streams to the participants) adds complexity to the data exchanges, as the means of communicating with a browser are limited and are subject to standards. Also, although the use of a browser to participate in this type of conference is advantageous, this use complicates the transfer of data streams during the conference session. It is particularly advantageous to use a browser since the various browsers on offer are maintained and regularly updated by their respective publishers and offer attractive performance in the context of processing and reading real-time data streams exchanged during the conference session. Furthermore, most computers are directly sold with a browser-type application already loaded, so a person possessing a computer does not need to download a dedicated application in order to participate in a conference session.

The inventor noted in particular that when a first participant in the conference session uses a browser, the conference session does not allow offering end-to-end encryption of a data stream sent by a second participant to the first participant. Indeed, the inventor shrewdly noted that the data stream transmitted by the second participant and encrypted by an encryption key used in the conference session is decrypted by the media server, before being re-encrypted using a key negotiated between the media server and the browser of the first participant. As a result, the data stream transmitted by the second participant to the first participant of the conference session is not a data stream with end-to-end encryption, because at one point it is decrypted by the media server before being re-encrypted and transmitted over the existing communication channel between the media server and the browser.

In particular, when the communication channel between the media server and the browser of the first participant uses a WebRTC application programming interface (referred to as “API” in the remainder of this disclosure), described in particular in the RFC 8835 standard, the specification of the communication channels proposed for communicating audio and/or video streams using the WebRTC API does not allow transmitting data streams other than audio and/or video data streams in compliance with the RTP protocol (unencrypted), which are then encrypted to be in compliance with the protocol, via the key negotiated according to the DTLS-SRTP protocol between the media server acting as a WebRTC client and the browser.

This disclosure therefore proposes a solution that allows end-to-end encryption to be implemented within the framework of a conference session, even in situations where a participant is using a browser to participate in the conference session, and even in situations where the browser uses the WebRTC API to communicate with the server. In particular, the solution proposes directly transmitting the encrypted stream with a first encryption key associated with the conference session, via the communication channel between the media server and the browser, this stream being encrypted a first time and therefore being encrypted again using the encryption key negotiated between the media server and the browser.

The browser will then decrypt this stream twice: a first decryption using the key negotiated between the media server and the browser, and a second decryption using a second key associated with the conference session, as detailed below. In particular, the browser, and more specifically the browser's JavaScript engine, will be able to execute code instructions to perform the second decryption using the second key associated with the conference session so that the data stream will have end-to-end encryption between the first participant and the second participant.

Furthermore, since a function comprising code instructions for decrypting the data stream has already been developed for participants not using a browser, the solution may also propose reusing this function, stored in a dedicated file in bytecode form, which will be loaded by the browser's JavaScript engine and which can be executed from the JavaScript engine. Thus, rather than developing a new JavaScript function for decrypting the data stream, which requires maintaining two different sets of code, the code is reused and the execution of such code in bytecode form allows for faster execution of the decryption function compared to this function being interpreted and executed based on JavaScript instructions.

An example of a communication architecture 1 in which a conference session enabling the exchange of multimedia data streams may be implemented is now described with reference to FIG. 1.

A data stream, or stream, is defined in this disclosure as corresponding to at least two successive data packets. An audio data stream, or audio stream, is defined as corresponding to at least two successive audio data packets. A video data stream, or video stream, is defined as corresponding to at least two successive video data packets.

In this disclosure, a multimedia stream may correspond to an audio data stream or to a video data stream. In audio-video conferences, both an audio data stream and a video data stream are transmitted, i.e. two multimedia streams of different types.

The communication architecture 1 comprises a media server 3, a first terminal 2a, and a second terminal 2b. The communication architecture 1 may comprise more than two terminals 2, and may comprise as many terminals as there are participants in the conference session. However, this patent application limits itself to representing the architecture with two terminals 2, since the solution proposed by this disclosure can be clearly understood with two terminals 2.

The conference session allows exchanging multimedia streams in near-real time between the terminals. The multimedia streams transmitted by the transmitting terminals during the conference session are sent to the media server 3, which can distribute them to the recipient terminals participating in the conference session. The media server 3 is sometimes referred to as a “session server”.

It should be noted that a terminal transmitting a first multimedia stream may subsequently or simultaneously be a terminal receiving a second multimedia stream sent by another transmitting terminal participating in the conference session.

In a first alternative, the conference session may thus designate an audio conference in which terminals may be induced to exchange audio streams via a media server 3, in near-real time.

In a second alternative, the conference session may designate a video conference in which terminals may be induced to exchange video streams via a media server 3, in near-real time.

In a third alternative, the conference session may designate an audio-video conference in which terminals may be induced to exchange audio and video streams via a media server 3, in near-real time.

It should be noted that in the first or third alternative, the audio streams may, for example, correspond to push-to-talk communications. Push-to-talk (also known as press-to-transmit) communications are two-way (non-simultaneous) communications based on the user pressing a physical or virtual button to switch from receive mode to transmit mode and vice versa. These communications use half-duplex communication channels.

A terminal may therefore correspond to a fixed or mobile communications device. A communications device is mobile in the sense that it is not connected to a communications network, either physically via a cable, or at a short distance, for example via the use of a Wi-Fi, NFC, or Bluetooth protocol. Instead, a mobile communications device is adapted to communicate data over long distances via a telecommunications network, for example a mobile network, so that it can exchange data while roaming. A mobile communications device may, for example, correspond to a cell phone.

During the conference session, the data packets of the multimedia streams sent by the terminals are encapsulated according to an Internet protocol. This protocol is defined in particular in the RFC 791 standard.

In this disclosure, the data streams exchanged by the terminals during the conference session may be encapsulated according to an SRTP protocol (Secure Real-time Transport Protocol). A data stream encapsulated according to an SRTP protocol is understood in the present application to be a data stream arranged to comply with an SRTP protocol, i.e. to comply with a protocol defined in particular in the RFC 3711 standard.

A multimedia stream sent by a transmitting terminal during the conference session is also encoded by an encoding codec implemented by the transmitting terminal. The encoding codecs differ depending on the type of data in the multimedia stream: audio or video.

In some examples, an audio encoding codec may correspond to one of the following: GSM, iLBC, Speex, AMR-WB, EVS, OPUS. In some examples, a video encoding codec may correspond to one of the following: VP8, VP9, AV1, H264.

A terminal 2 may comprise a processor 21 and a memory 22. The processor 21 may be adapted to implement functions utilized by the terminal 2. In other words, a processor of the first terminal 2a may be configured to implement functions utilized by the first terminal 2a while a processor of the second terminal 2b may be configured to implement functions utilized by the second terminal 2b. The processor 21 may for example be a microprocessor. The processor 21 may in particular be a component of an integrated circuit, in particular a component of a microcontroller, a component of an FPGA (Field-Programmable Gate Array), or a component of an ASIC (Application-Specific Integrated Circuit).

The memory 22 may store code instructions executed by the processor 21. The memory 22 may, for example, comprise a ROM (Read-Only Memory), a RAM (Random Access Memory), an EEPROM (Electrically Erasable Programmable Read Only Memory), or any other type of suitable storage means. The memory may, for example, comprise optical, electronic, or magnetic storage means.

A terminal 2 may also comprise a microphone 23 for capturing an audio stream.

A terminal 2 may also comprise a camera 24 for capturing a video stream.

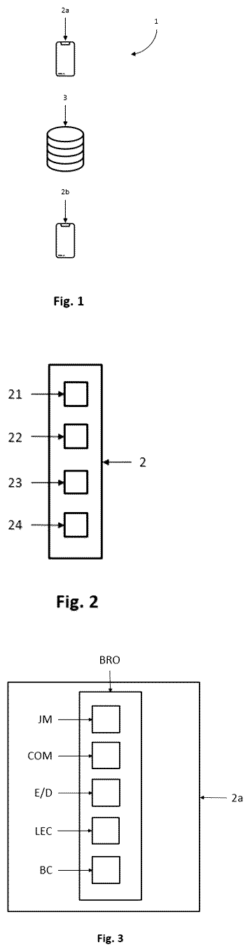

An example of a terminal 2 comprising a processor 21, a memory 22, a microphone 23, and a camera 24 is illustrated in particular in FIG. 2.

An example of a first terminal 2a is shown in FIG. 3. In this example, the terminal 2a comprises a browser BRO.

Browser BRO designates a software unit designed for accessing and displaying the World Wide Web, in particular by interpreting and executing code instructions in the JavaScript language. The browser BRO thus corresponds to software implementing HTTP (Hypertext Transfer Protocol) requests which allow connecting to HTTP servers (web servers). The browser BRO corresponds, for example, to the browsers known to the general public. The browser BRO may comprise several modules developed by respective publishers which will be detailed in particular below. Consequently, by relying on an existing browser BRO, it becomes unnecessary to develop and maintain modules already offered by the browser.

A software unit may in particular be implemented by the processor 21 of a terminal. Consequently, the browser BRO may be implemented by the processor 21 of the first terminal 2a.

The browser BRO comprises a JavaScript engine JM, which designates the software unit allowing the interpretation and execution of code instructions in the JavaScript language in order to execute the various functions and modules of the browser BRO.

The browser BRO also comprises a communication module COM which allows it to communicate with the media server 3. In such case, the media server 3 may comprise a corresponding communication module. The communication module COM allows establishing an encrypted communication channel between the browser BRO of the first terminal 2a and the media server 3. The creation of the encrypted communication channel between the first terminal 2a and the media server 3 may be initiated by the media server 3 (via its communication module) or by the first terminal 2a. In particular, the communication module COM of the browser of the first terminal 2a allows exchanging (i.e. sending and receiving) multimedia streams with the media server 3.

In a first alternative, the communication module COM may for example comprise a WebRTC API. The media server 3 may then also comprise a WebRTC API for communicating with the corresponding WebRTC API of the first terminal 2a. In this first alternative, an encryption key for encrypting exchanges on the communication channel is negotiated between the media server 3 and the browser BRO of the first terminal 2a according to a DTLS-SRTP (Datagram Transport Layer Security-Secure Real Time Protocol) protocol defined in particular by the RFC 5764 standard. It should be noted that the multimedia data streams are exchanged via a data channel (“Datachannel” in the WebRTC API specification) of the WebRTC API, and not via the function defined for transmitting multimedia streams according to the WebRTC API specification. Indeed, the WebRTC API specification defines a function for transmitting multimedia streams, but this function does not allow already encrypted multimedia streams to be transmitted. The inventor therefore cleverly diverted to using the WebRTC API to transmit encrypted multimedia streams via a particular communication channel, called the Datachannel in the WebRTC API, instead of using the function defined by the WebRTC API to transmit these multimedia streams, which, since this function does not allow the transmission of already encrypted streams, requires decrypting the stream before retransmitting it and therefore does not allow end-to-end encryption.

In a second alternative, the communication module COM may, for example, comprise a WebSocket module which allows communication to be established with the media server 3 in accordance with the WebSocket protocol. The WebSocket protocol is defined in particular in the RFC 6455 standard. In this second alternative, an encryption key for encrypting exchanges on the communication channel is negotiated between the media server 3 and the browser BRO of the first terminal 2a according to a TLS (Transport Layer Security) protocol defined in particular by the RFC 8446 standard for its version 1.3 (other versions may of course be considered). The communication channel created in accordance with the WebSocket protocol allows encrypted multimedia streams to be exchanged without having to decrypt them before re-encrypting them via the key negotiated according to the TLS protocol. It should be noted that the use of the WebSocket protocol to transmit multimedia streams of conference sessions, which must be transmitted in near real-time, is an ingenious use of this protocol which was not originally intended for this type of communication. Indeed, the WebSocket protocol is configured for exchanging data packets in accordance with the TCP protocol (Transmission Control Protocol, defined in particular in the RFC 793 standard), which is not the preferred protocol for exchanging SRTP data packets. More specifically, data transmission using the UDP (User Datagram Protocol) protocol has less latency than the TCP protocol and does not interrupt the data flow in the event of packet loss, unlike the TCP protocol, so the TCP protocol is not chosen for real-time communications. This second alternative therefore involves a clever use of the WebSocket protocol to transmit SRTP data packets using the TCP protocol.

In some examples, the browser BRO may comprise a coding module E/D that corresponds to a software unit for encoding multimedia streams or decoding multimedia streams. More specifically, the coding module E/D is configured to allow encoding and decoding a data stream using a plurality of codecs supported by the module E/D. A coding module E/D for the browser BRO may, for example, correspond to a WebCodecs API. The WebCodecs API is a standard proposed by the World Wide Web Consortium (W3C) that enables multimedia stream decoding and encoding operations to be performed via a browser.

In some examples, the browser BRO may comprise a multimedia stream playback module LEC. The playback module LEC is a software unit that may, in particular, play a decoded multimedia data stream. The multimedia data stream may, for example, be decoded by the coding module E/D and then provided to the playback module LEC for playback. The module LEC may, in particular, comprise an audio stream playback module and/or a video stream playback module, depending on the nature of the conference session. The audio stream playback module LEC may, for example, comprise a WebAudio API which allows playing an audio stream formatted in particular according to pulse code modulation (PCM).

In some examples, the browser BRO may also comprise a bytecode module BC. A bytecode module BC may correspond to a software unit allowing the JavaScript engine JM to load and use functions included in a bytecode file. In this regard, the bytecode module BC may be implemented directly in the JavaScript engine JM, or may be a different module than the JavaScript engine JM but usable by the JavaScript engine JM, as shown in FIG. 3.

A bytecode file refers to a file comprising data represented in bytecode form, i.e. data having an intermediate format between source code, written by a developer or by an intelligent model, and machine code, executed by a processor. Bytecode is sometimes referred to as “intermediate code” or “byte code” in the technical literature. Thus, a bytecode file may correspond in particular to a file comprising already compiled code instructions.

A bytecode file may therefore include one or more functions, in particular a library of functions, which, once imported by the JavaScript engine by means of the bytecode module BC, can be used by the JavaScript engine JM. The advantage of the bytecode module BC is that it allows the use of functions coded in programming languages other than JavaScript, precompiled and stored in a bytecode file, so that when these functions are executed by the JavaScript engine, they are executed more quickly. Furthermore, as mentioned above, this also avoids having to maintain functions intended to do the same thing, in several different programming languages.

In these examples, the bytecode module BC may comprise a module allowing the JavaScript engine JM to load and use functions included in a WebAssembly file. A WebAssembly file has a file extension “.wasm”. WebAssembly is a standard proposed by the Word Wide Web Consortium. It should be noted that the bytecode module BC may of course include other modules allowing the JavaScript engine JM to load and use functions included in bytecode file types other than WebAssembly.

The first terminal 2a may thus store a bytecode file, for example in its memory 22, comprising a decryption function for decrypting a multimedia stream. The decryption function may in particular decrypt the multimedia stream using an encryption key associated with the conference session. The stored bytecode file may, for example, correspond to a WebAssembly type of file.

When mention is made in this disclosure of an encryption key associated with the conference session, at least two different options are conceivable for accessing this encryption key.

In a first option, a same encryption key is shared among all the terminals participating in the conference session. In this case, a transmitting terminal encrypts a multimedia data stream that it transmits, using this encryption key, and a receiving terminal decrypts a multimedia data stream that it receives, using this key. In this first option, the encryption of data streams in the conference session is symmetric.

In a second option, a specific terminal participating in the conference session obtains a public encryption key with which it encrypts the data streams that it transmits. Furthermore, each of the other terminals participating in the conference session (i.e. terminals other than the specific terminal) obtains a private encryption key (or information allowing retrieval of the private encryption key) associated with the public encryption key of the specific terminal, and allowing the decryption of data streams transmitted by the specific terminal encrypted by the public key. Therefore, each terminal in the conference session stores a public key, and at least one private key (in practice a plurality of private keys), where each private key is associated with a public key of another terminal participating in the conference session. Thus, a given terminal in the conference session can decrypt, with the private key associated with the public key of another terminal in the conference session, the data streams transmitted by that other terminal. In this second option, the encryption of data streams in the conference session is asymmetric.

The encryption keys, whether in the context of symmetric or asymmetric encryption, may be transmitted to the terminals of the conference session by the media server 3, or by a key management server, also known as a Key Management System (KMS). When a private key is not transmitted directly to a terminal, information which allows determining this private key at the terminal may be sent by the media server 3 or by the key management server (KMS).

In some examples, the bytecode file including the decryption function may also include a function for decoding a multimedia stream encoded using a first codec, and possibly using other codecs. In other examples, the terminal 2a stores another bytecode file comprising the decoding function for decoding a multimedia stream encoded using the first codec and possibly using other codecs. The first codec may in particular correspond to an AMR-WB, EVS, or OPUS codec. The decoding function makes it possible, for example, to decode a multimedia stream encoded with a specific codec, so as to have access to an audio stream which allows it to be played by an audio player, in particular by the player LEC. The bytecode file decoding function may thus allow decoding audio data streams encoded with codecs that are not offered in the plurality of codecs supported by module E/D of the browser.

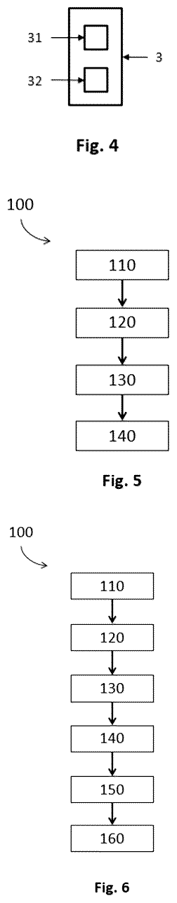

A media server 3 may comprise a processor 31 and a memory 32. An example of a media server 3 comprising a processor 31 and a memory 32 is illustrated in particular in FIG. 4. The processor 31 may be adapted to implement functions utilized by the media server 3 in this disclosure. The processor 31 may, for example, be a microprocessor. The processor 31 may in particular be a component of an integrated circuit, in particular a component of a microcontroller, a component of an FPGA (Field-Programmable Gate Array), or a component of an ASIC (Application-Specific Integrated Circuit).

The memory 32 may store code instructions executed by the processor 31. The memory 32 may, for example, comprise a ROM (Read-Only Memory), a RAM (Random Access Memory), an EEPROM (Electrically Erasable Programmable Read Only Memory), or any other type of suitable storage means. The memory 32 may, for example, comprise optical, electronic, or magnetic storage means.

The media server 3 may also comprise a communication module (not shown) which allows establishing a communication channel with the first terminal 2a. The communication module may comprise a WebRTC API and/or a WebSocket module for communicating with a corresponding API or module of the first terminal 2a. These modules may be implemented by the processor 31 of the media server 3.

Examples of methods for exchanging data with end-to-end encryption between the first terminal 2a and the second terminal 2b participating in a conference session managed by the media server 3 are now described with reference to FIGS. 5 to 9. As explained above, the media server 3 transmits multimedia data streams in real time to the participants in the conference session. Furthermore, a communication channel is established between the media server 3 and the browser BRO of the first terminal 2a. The conditions for establishing this communication channel have also been described above.

It should be noted that the figures associated with the examples of the method 100 are simply illustrations of examples of the method 100 which use blocks to represent the various operations that may be included in the method and are described in the remainder of this document. As such, the illustrations do not show any sequentiality between the operations. In other words, the operations described with reference to the figures are not necessarily implemented one after the other and may in particular be implemented in a different order than what is shown in the figures, or may be implemented in parallel, unless a given operation requires a result from another operation in order to be implemented. Similarly, it is not necessary for each operation to be implemented a first time before the same operation is repeated a second time. The frequency of implementation of each operation is specific to it and is not necessarily linked to the implementation of the other operations.

As illustrated by block 110, this exemplary method 100 comprises a first encryption of a multimedia stream to be transmitted to the participants of the conference session. The first encryption 110 is performed by the second terminal 2b, for example by its processor, using a first encryption key associated with the conference session. The conditions for obtaining an encryption key associated with the conference session have been described above.

As illustrated by block 120, the exemplary method 100 comprises sending the encrypted multimedia stream to the media server 3. This sending is performed by the second terminal 2b, and may for example be implemented by its processor. As a result, the media server 3 receives the multimedia stream encrypted using the first encryption key associated with the conference session, from the second terminal 2b.

As illustrated by block 130, the exemplary method 100 comprises a second encryption of the already-encrypted multimedia stream. The second encryption is performed by the media server 3, for example by its processor 31, using an encryption key negotiated between the browser BRO of the first terminal 2a and the media server 3 for communicating on the communication channel. Details on the encryption key negotiated between the browser BRO of the first terminal 2a and the media server 3 have been described above. It is therefore understood that after block 130, the multimedia stream transmitted by the second terminal 2b is encrypted by two different encryption keys: the first encryption key associated with the conference session, and the encryption key negotiated between the media server 3 and the browser BRO of the first terminal 2a.

As illustrated by block 140, the exemplary method 100 comprises sending the multimedia stream to the first terminal 2a. The multimedia stream is sent by the media server 3, for example following a command from its processor 31, and corresponds to the multimedia stream that was encrypted twice using the two encryption keys. The twice-encrypted multimedia stream is sent over the communication channel established between the media server 3 and the browser BRO of the first terminal 2a.

Thus, the method 100 according to this disclosure allows sending a multimedia stream with end-to-end encryption, between a first terminal 2a participating in the conference session via its browser and a second terminal 2b also participating in the conference session. The multimedia stream is not decrypted at the media server 3 before being retransmitted over the communication channel established between the media server 3 and the browser of the first terminal 2a.

In some examples and as illustrated by block 150, the method 100 may further comprise a first decryption of the multimedia stream received from the media server 3. The first decryption is performed by the first terminal 2a, for example by its processor, using the encryption key negotiated between its browser BRO and the media server 3.

In some examples and as illustrated by block 160, the method 100 may further comprise a second decryption of the multimedia stream that has already been decrypted a first time in block 150. The second decryption is performed by the first terminal 2a, for example by its processor, using a second encryption key which allows decrypting a multimedia stream encrypted by the first encryption key.

In a first option where the encryption is symmetric, the second encryption key may correspond to the first encryption key. In a second option where the encryption is asymmetric, the first encryption key may correspond to the public key of the second terminal 2b, and the second encryption key may correspond to the private key associated with the public key of the second terminal 2b.

Examples of methods 100 comprising the first and second decryptions are illustrated in particular in FIG. 6.

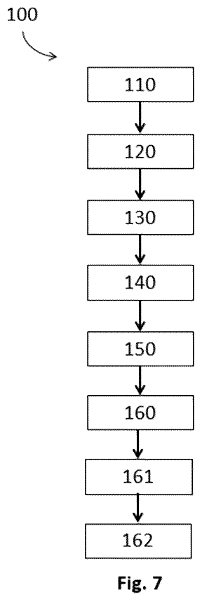

In examples, the second decryption block 160 may comprise a block 161 and a block 162. These examples are illustrated in particular in FIG. 7.

Block 161 may correspond to loading a bytecode file comprising a decryption function for decrypting a data stream. The loading may in particular be carried out by the JavaScript engine JM of the browser BRO of the first terminal 2a, using the bytecode module BC. The bytecode file may in particular be a WebAssembly file, as explained above.

Block 162 may correspond to executing the decryption function on the multimedia stream already decrypted a first time. Execution of the decryption function may in particular be carried out by the JavaScript engine JM of the browser BRO of the first terminal 2a, using the bytecode module BC. The decryption function for decrypting the data stream of the bytecode file may thus rely on the second encryption key, which allows decrypting a multimedia stream encrypted by the first encryption key, to perform the decryption.

In some examples, the method 100 may further comprise encoding the multimedia stream using the first codec. This encoding is represented by block 105 in FIG. 8. The encoding is performed by the second terminal 2b, in particular before the first encryption offered by block 110. As a result, when the multimedia stream is received by the first terminal 2a, it is encoded by the first codec in addition to being encrypted by two different encryption keys.

In some examples comprising block 105 and in a first alternative where the first codec is one among the plurality of codecs supported by the coding module E/D of the browser BRO of the first terminal 2a, the method 100 may further comprise decoding the multimedia stream using the coding module of the browser BRO. The decoding is illustrated by block 170 in FIG. 8. This first alternative allows decoding via the decoding module E/D of the BRO browser, which is executed faster than the decoding in the second alternative presented below since it can be performed directly in the native environment of the processor of the first terminal 2a. On the other hand, the browser's decoding module E/D is limited to a certain number of codecs, and in particular does not support widely used codecs such as AMR-WB.

In some examples comprising block 105 and in a second alternative where the first codec is not among the plurality of codecs supported by the coding module E/D of the browser BRO of the first terminal 2a, the method 100 may further comprise a block 180 and a block 181, as illustrated in FIG. 8.

Block 180 may correspond to loading a bytecode file comprising a decoding function for decoding a data stream encoded using the first codec. The bytecode file may be a WebAssembly file. The bytecode file may be the same as the one comprising the decryption function that is loaded during block 161, or it may be a different file. When it is the same file, it is not necessary to load it twice. The loading of the bytecode file may in particular be carried out by the JavaScript engine JM of the browser BRO of the first terminal 2a, using the bytecode module BC.

Block 181 may correspond to executing the decoding function on the multimedia stream encoded by the first codec and loaded during block 180. The execution of the decoding function may in particular be implemented by the JavaScript engine JM of the browser BRO of the first terminal 2a, using the bytecode module BC.

In this second alternative, as the decoding function is executed by the JavaScript engine JM of the browser BRO, this function is not executed directly by the processor of the first terminal 2a, but is executed via the JavaScript engine JM which is simulated by this processor. Since the execution of the decoding function is implemented in an environment simulated by the processor, and not directly in the native environment of the processor, the decoding is not performed as quickly as in the first alternative. On the other hand, this second alternative makes it possible to decode multimedia streams encoded by codecs not supported by the coding module E/D, such that any codec may be used for the conference session.

In a first option in which the communication channel between the media server 3 and the browser BRO is established using a WebRTC API, the block 140 in which the multimedia stream is sent from the media server 3 to the browser BRO of the first terminal 2a may comprise a block 141. Block 141 may comprise writing the multimedia stream to a data channel (DataChannel) of the WebRTC API, created between the media server 3 and the browser BRO. As explained above, it is the writing of the multimedia stream to a data channel (DataChannel) of the WebRTC API which makes it possible to avoid decrypting the multimedia stream at the media server 3.

In a second option in which the communication channel between the media server 3 and the browser BRO is established using a Websocket protocol, the block 140 in which the multimedia stream is sent from the media server 3 to the browser BRO of the first terminal 2a may comprise a block 142. Block 142 may comprise writing the multimedia stream to the communication channel established using the WebSocket protocol. The communication channel established using the WebSocket protocol is opened between the media server 3 and the browser BRO of the first terminal.

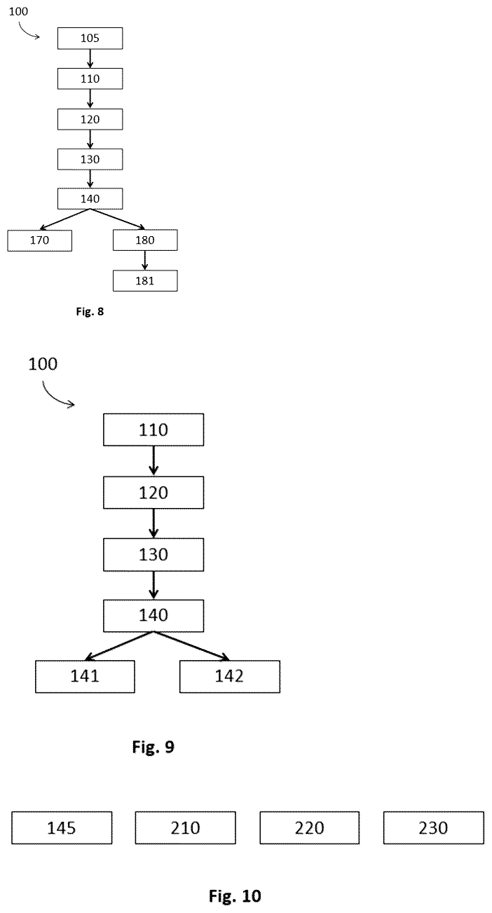

These two alternatives, comprising blocks 141 and 142, are represented in particular in FIG. 9.

Example configurations of a terminal according to this disclosure are now presented with reference to FIG. 10. The terminal is adapted to participate in a conference session managed by a media server 3. It comprises a browser BRO which may comprise any of the elements presented for the first terminal 2a. A communication channel is established between the media server 3 and the terminal's browser BRO.

The terminal may be configured to implement at least one of the operations presented below, for example by means of its processor. Furthermore, the terminal may be configured to implement at least one operation performed by the first terminal 2a and described implicitly or explicitly with reference to any of the exemplary methods 100 of this disclosure. For brevity, the operations already described as being performed by the first terminal 2a in the various exemplary methods 100 are not described again here.

The terminal may be configured to establish a communication channel between its browser BRO and the media server 3. Examples of modules or APIs for establishing such a channel have been described in this disclosure. This operation of establishing a communication channel is represented by block 145 in FIG. 10.

The terminal may be configured to perform a first encryption of a multimedia stream that it has captured, for example via its microphone 23 or its camera 24. The first encryption is performed using a third encryption key associated with the conference session. In a first option where the encryption is symmetric, the third encryption key may correspond to the encryption key of the conference session. In a second option where the encryption is asymmetric, the third encryption key may correspond to the public key of the terminal. In the latter case, the multimedia stream encrypted by the public key of the terminal may be decrypted using the private key associated with the public key of this terminal, as explained above. This first encryption operation is represented by block 210 in FIG. 10.

The terminal may be configured to perform a second encryption of the multimedia stream already encrypted a first time by the third encryption key. The second encryption is performed using an encryption key negotiated between the terminal's browser BRO and the media server 3. It is understood that the negotiated encryption key used here depends on how the communication channel is established between the browser BRO and the media server, in particular whether it is a communication channel established according to the WebSocket protocol, or using the WebRTC API. This second encryption operation is represented by block 220 in FIG. 10.

The terminal may be configured to transmit a multimedia stream encrypted a first time using the third encryption key and a second time using the encryption key negotiated between the terminal's browser BRO and the media server. This operation of transmitting the multimedia stream encrypted by two different encryption keys is represented by block 230 in FIG. 10.

In a first alternative, block 230 for transmitting the twice-encrypted multimedia stream may, for example, comprise writing the twice-encrypted multimedia stream to the communication channel linking the browser and the media server 3, opened in accordance with the WebSocket protocol.

In a second alternative, block 230 for transmitting the twice-encrypted multimedia stream may, for example, comprise writing the twice-encrypted multimedia stream to a data channel of the communication channel linking the browser and the media server 3, created using the WebRTC API.

The exemplary configurations of the terminal according to this disclosure therefore allow the terminal to send and receive encrypted streams using its browser within the framework of a conference session, without these streams being decrypted by the media server 3. Thus, the configurations of the terminal according to this disclosure make it possible to apply end-to-end encryption to the communications.

This patent application further relates to a media server 3 according to any of the configurations presented by this disclosure. The media server 3 may be configured to implement at least one of the operations presented with reference to the exemplary methods 100, for example by means of its processor 31.

Thus, the media server according to this disclosure allows offering end-to-end encryption of the multimedia streams exchanged by the terminals participating in the conference session that it manages, even if the terminals exchange multimedia streams via their browser.

The application further relates to a computer program product comprising instructions for implementing any of the configurations of a terminal or media server presented by this disclosure, when this configuration is implemented by a processor.

Finally, the application relates to a non-transitory computer-readable storage medium on which is stored a program for implementing any of the configurations of a terminal or media server presented by this disclosure, when this configuration is implemented by a processor.

The various examples and configurations described in the present patent application may optionally be combined to implement other examples or configurations. Furthermore, in the claims which follow, the terms used are not to be interpreted as limiting these claims to the specific examples or configurations disclosed in the description, but are to be interpreted as including all possible examples and configurations as well as any elements equivalent to an element indicated in the claims.

1. A method for exchanging data with end-to-end encryption between a first terminal and a second terminal participating in a conference session managed by a media server, wherein a communication channel is established between the media server and a browser of the first terminal, and wherein the method comprises:
a first encryption of a multimedia stream by the second terminal, using a first encryption key associated with the conference session;
a sending of the encrypted multimedia stream to the media server, by the second terminal;
a second encryption of the already-encrypted multimedia stream, by the media server, using an encryption key negotiated between the browser of the first terminal and the media server for communicating on the communication channel; then
a sending of the multimedia stream to the first terminal, by the media server.

2. A method according to claim 1, further comprising:
a first decryption, by the first terminal, of the multimedia stream received from the media server, using the encryption key negotiated between the browser of the first terminal and the media server; and
a second decryption of the multimedia stream, by the first terminal, using a second encryption key, which allows decrypting a multimedia stream encrypted by the first encryption key.

3. A method according to claim 2, wherein the second decryption comprises:
loading a bytecode file comprising a decryption function for decrypting a data stream; and
executing the decryption function on the multimedia stream.

4. A method according to claim 1, wherein the browser of the first terminal further comprises a coding module which allows encoding or decoding multimedia streams using a plurality of codecs, wherein the method further comprises:
an encoding of the multimedia stream by the second terminal, using a first codec; and
when the first codec is one among the plurality of codecs:
a decoding of the multimedia stream using the coding module of the browser.

5. A method according to claim 4, wherein when the first codec is not one among the plurality of codecs supported by the coding module, the method further comprises:
loading a bytecode file comprising a decoding function for decoding a data stream encoded using the first codec; and
executing the decoding function on the multimedia stream encoded by the first codec.

6. A mthod according to claim 1, wherein the communication channel between the media server and the browser is established in accordance with a WebSocket protocol;
wherein a sending of the multimedia stream to the first terminal, by the media server, via the communication channel established between the media server and the browser of the first terminal, comprises:
writing the multimedia stream to the communication channel established between the media server and the browser.

7. A terminal adapted for connecting to a conference session managed by a media server, the terminal comprising a browser, wherein the terminal is configured for:
applying a first encryption of a multimedia stream using a third encryption key associated with the conference session;
applying a second encryption of the multimedia stream that was encrypted using the third encryption key, using an encryption key negotiated between the browser and the media server to encrypt the multimedia streams exchanged between the media server and the browser; and
transmitting the encrypted multimedia stream to the media server.

8. A terminal according to claim 7, wherein the terminal is also configured for:
obtaining, from the media server, a multimedia stream encrypted a first time using a first encryption key of another terminal participating in the conference, and encrypted a second time using an encryption key negotiated between the browser and the media server to encrypt the multimedia streams exchanged between the media server and the browser;
applying a first decryption of the multimedia stream received from the media server, using the encryption key negotiated between the browser and the media server; and
applying a second decryption of the multimedia stream received from the media server, using a second encryption key which allows decrypting a multimedia stream encrypted by the first encryption key.

9. A terminal according to claim 8, wherein the application of the second decryption of the multimedia stream comprises:
loading a bytecode file comprising a decryption function for decrypting a data stream; and
executing the decryption function on the multimedia stream.

10. A media server, configured for managing a conference session in which at least a first terminal and a second terminal are participating, wherein the media server is configured for:
receiving, from the second terminal, an encrypted multimedia stream to be transmitted to the other participants in the conference session; and
encrypting the already encrypted multimedia stream, using an encryption key negotiated with a browser of the first terminal.
